(19) United States
(12) Patent Application Publication
(10) Pub. No.: US 2016/0372257 A1
(43) Pub. Date: Dec. 22, 2016

(54) NOVEL STACKED INDUCTOR AND ELECTRONIC COMPONENT MODULE HAVING THE NOVEL STACKED INDUCTOR

(71) Applicant: ACX CORPORATION, Hsinchu County (TW)

(72) Inventors: CHIN-LI WANG, Hsinchu City (TW); CHIH-MING CHANG, New Taipei City (TW)

(21) Appl. No.: 14/741,594

(22) Filed: Jun. 17, 2015

(51) Int. Cl. H01F 27/29; H01F 1/147; H01F 1/14; H01F 27/28

(52) U.S. Cl. CPC H01F 27/29; H01F 27/2823; H01F 1/147; H01F 1/14

(57) ABSTRACT

The present invention provides a novel stacked inductor and an electronic component module having the novel stacked inductor, wherein the multilayer stacked inductor is fabricated by stacking a top magnetic material layer, a plurality of first middle magnetic material layers, at least one second middle magnetic material layer, at least one non-magnetic material layer, and a bottom magnetic material layer. In the present invention, a second metal layer formed on the non-magnetic material layer and a first metal layer formed on the first middle magnetic material layer have a first line width ratio, and a third metal layer formed on the second middle magnetic material layer and the first metal layer have a second line width ratio. Therefore, the DC resistance and the quality factor of this novel multilayer stacked inductor can be optimized based on the first and second line width ratio.

### BACKGROUND OF THE INVENTION

1. Field of the Invention

The present invention relates to the technology field of inductor components, and more particularly to a novel stacked inductor and an electronic component module having the novel stacked inductor.

2. Description of the Prior Art

Inductor, one of passive components, is widely applied in various consumer electronic products. Nowadays, inductor components can be mainly divided into THD (through hole device) inductor components and SMD (surface-mount device) inductor components. In which, the SMD inductor components can be further divided into three types of: multilayer SMD inductors, wire-wound SMD inductors and film-chip SMD inductors.

Referring to FIG. 1, there illustrates a stereo view of a conventional multilayer stacked inductor. As shown FIG. 1, the conventional multilayer stacked inductor 1′ basely consists of a main body 11′, a first welding electrode 14′ and a second welding electrode 15′, wherein the first welding electrode 14′ and the second welding electrode 15′ are respectively formed on the two sides of the main body 11′.

Please simultaneously refer to FIG. 2, where a cross sectional view of the conventional multilayer stacked inductor 1′ is shown. The cross sectional diagram of FIG. 2 is obtained by cutting the multilayer stacked inductor 1′ along the A-A profile line shown in FIG. 1. Therefore, from the cross sectional diagram, it is able to find that the main body 11′ of the multilayer stacked inductor 1′ is consisted of a magnetic material unit 12′ and a helical coil unit 13′. Please simultaneously refer to an exploded view of the helical coil unit 13′ shown by FIG. 3. Although the helical coil unit 13′ is enclosed by the magnetic material unit 12′, the helical coil unit 13′ is fabricated by stacking a first layer ML1′, a second layer ML2′, a third layer ML3′, a fourth layer ML4′, a fifth layer ML5′, and a sixth layer ML6′.

As shown in FIG. 3, a first coil segment CS1′ with “ [symbol] ”-shaped appearance, a second coil segment CS2′ with “ [symbol] ”-shaped appearance, a third coil segment CS3′ with “ [symbol] ”-shaped appearance, and a fourth coil segment CS4′ with “ [symbol] ”-shaped appearance are formed on the first layer ML1′, the second layer ML2′, the third layer ML3′, and the fourth layer ML4′, respectively. In addition, a fifth coil segment CS5′ with straight appearance is provided on the fifth layer ML5′. Moreover, as shown in FIG. 2 and FIG. 3, a first extension segment LS1′ and a second extension segment LS2′ are respectively extended from the first coil segment CS1′ and the fifth coil segment CS5′, used for connecting the first welding electrode 14′ and the second welding electrode 15′. Furthermore, in order to make all of the coil segments (CS1′˜CS5′) connect with each other, the first layer ML1′, the second layer ML2′, the third layer ML3′, and the fourth layer ML4′ are dug with a first through hole TH1′, a second through hole TH2′, a third through hole TH3′, and a fourth through hole TH4′, respectively.

In general, the aforesaid first layer ML1′, second layer ML2′, third layer ML3′, and fourth layer ML4′ are fabricated by printing conductor patterns (i.e., the first coil segment CS1, the second coil segment CS2′, the third coil segment CS3′, and the fourth coil segment CS4′) on to corresponding ceramic green sheets made of at least one high magnetic-permeability material. However, although the conventional multilayer stacked inductor 1′ shown by FIG. 1-FIG. 3 includes high inductance, the multilayer stacked inductor 1′ still cannot be applied into the power supplies resulted from the limitations caused by its low saturation current.

Accordingly, manufacturing companies of passive components try to fabricate the ceramic green sheet by using non-magnetic materials, and then replace the one or more stacked layers (i.e., the first layer ML1′, the second layer ML2′, the third layer ML3′, the fourth layer ML4′, or the fifth layer ML5′) with the non-magnetic ceramic green sheets, such that an improved helical coil unit is therefore developed. Please refer to FIG. 4, where an exploded view of the improved helical coil unit is shown. In the improved helical coil unit 13a′, the first layer ML1′, the second layer ML2′ and the fifth layer ML5′ are made of the high magnetic-permeability materials. Opposite to the first layer ML1′, the second layer ML2′ and the fifth layer ML5′, the second layer ML2′ and the third layer ML3′ are fabricated by using non-magnetic materials. By such design for those stacked layers, the inductance of the multilayer stacked inductor having the improved helical coil unit 13a′ can obviously enhanced, such that the multilayer stacked inductor having the improved helical coil unit 13a′ can be applied in a switch power supply. Furthermore, for increasing the energy conversion efficiency of the switch power supply, the manufacturing companies of passive components try to evenly increase the line width of the printed metal layers of each of the stacked layers, so as to carry out the reduction of metal loss by lowering the DC resistance of the multilayer stacked.

However, although the improved helical coil unit 13a′ is now widely used in the multilayer-stacked power inductor, the multilayer-stacked power inductor is subject to some limitations in aspect of high-frequency communication due to its low quality factor (Q).

Accordingly, in view of the conventional multilayer stacked inductor 1′ and the multilayer stacked inductor having the improved helical coil unit 13a′ still include drawbacks and shortcomings, the inventor of the present application has made great efforts to make inventive research thereon and eventually provided a novel stacked inductor and an electronic component module having the novel stacked inductor.

### SUMMARY OF THE INVENTION

The primary objective of the present invention is to provide a novel multilayer stacked inductor and an electronic component module having the novel multilayer stacked inductor. Differing from the conventional multilayer stacked inductor shown by FIG. 3 and FIG. 4, the novel multilayer stacked inductor proposed by the present invention is fabricated by stacking a top magnetic material layer, a plurality of first middle magnetic material layers, at least one second middle magnetic material layer, at least one non-magnetic material layer, and a bottom magnetic material layer. Particularly, a second metal layer formed on the non-magnetic material layer and a first metal layer formed on the first middle magnetic material layer adjacent to the non-magnetic material layer are design to have a first line width ratio, and a third metal layer formed on the second middle magnetic material layer and the first metal layer formed on the first middle magnetic material layer adjacent to the second middle magnetic material layer are design to have a second line width ratio. Preferably, the first line width ratio and the second line width ratio are ranged between 0.60 and 0.85. Therefore, the DC resistance of the novel multilayer stacked inductor is slightly optimized based on the first and second line width ratio; moreover, the quality factor of the novel multilayer stacked inductor can be determined to be enhance with the increasing of the inductance through the formula of Q=ωL/R.

Accordingly, in order to achieve the primary objective of the present invention, the inventor of the present invention provides a novel multilayer stacked inductor, comprising:

a main body, fabricated by stacking a top magnetic material layer, a plurality of first middle magnetic material layers, at least one non-magnetic material layer, and a bottom magnetic material layer, wherein each the non-magnetic material layer is disposed between two first middle magnetic material layers;

a first welding electrode, formed on one terminal side of the main body;

a second welding electrode, formed on another one terminal side of the main body;

wherein each the first middle magnetic material layer and each the non-magnetic material layer are respectively provided with a first metal layer and a second metal layer thereon, and a bottom metal layer is formed on the bottom magnetic material layer;

wherein the second metal layer of the non-magnetic material layer and the first metal layer of the first middle magnetic material layer adjacent to the non-magnetic material layer have a first line width ratio, and the first line width ratio is ranged from 0.60 to 0.85;

wherein all of the first metal layers on the plurality of first middle magnetic material layers, all of the second layers on the at least one non-magnetic material layer, and the bottom metal layer on the bottom magnetic material layer are connect with each other by end to end way, so as to jointly form a metal coil; moreover, two terminals of the metal coil are connected to the first welding electrode and the second welding electrode.

According to the preferable embodiment of the present invention, the aforesaid novel multilayer stacked inductor further comprises at least one second middle magnetic material layer disposed below the non-magnetic material layer; wherein each the second middle magnetic material layer is provided with a third metal layer thereon, and all the third metal layers, the first metal layers, the second metal layers, and the bottom metal layers are connected with each other by end to end way, so as to jointly form the metal coil. Moreover, the third metal layer on the second middle magnetic material layer and the first metal layer on the first middle magnetic material layer adjacent to the second middle magnetic material layer have a second line width ratio, and the line width ratio is ranged between 0.60 and 0.85.

Moreover, for achieving the primary objective of the present invention, the inventor of the present invention provides an electronic component module, comprising:

a novel multilayer stacked inductor, consisting of a main body, a plurality of first welding electrodes and a plurality of second welding electrodes; in the novel multilayer stacked inductor, the main body is fabricated by stacking a top magnetic material layer, a plurality of first middle magnetic material layers, at least one non-magnetic material layer, a bottom magnetic material layer, and a soldering layer, wherein each the non-magnetic material layer is disposed between two first middle magnetic material layers; moreover, the first welding electrodes are formed on the top magnetic material layer, and the second welding electrodes are formed the soldering layer so as to electrically connect to the first welding electrodes, respectively;

at least one electronic component, disposed on the top magnetic material layer by way of being welded onto the first welding electrodes;

wherein each the first middle magnetic material layer and each the non-magnetic material layer are respectively provided with a first metal layer and a second metal layer thereon, and a bottom metal layer is formed on the bottom magnetic material layer;

wherein the second metal layer of the non-magnetic material layer and the first metal layer of the first middle magnetic material layer adjacent to the non-magnetic material layer have a first line width ratio, and the first line width ratio is ranged from 0.60 to 0.85;

wherein all of the first metal layers on the plurality of first middle magnetic material layers, all of the second layers on the at least one non-magnetic material layer, and the bottom metal layer on the bottom magnetic material layer are connected with each other by end to end way, so as to jointly form a metal coil; moreover, one terminal of the metal coil is electrically connected to one of the plurality of first welding electrodes, and the other one terminal of the metal coil is electrically connected to one of the plurality of second welding electrodes.

According to the preferable embodiment of the present invention, the aforesaid novel multilayer stacked inductor further comprises at least one second middle magnetic material layer disposed below the non-magnetic material layer; wherein each the second middle magnetic material layer is provided with a third metal layer thereon, and all the third metal layers, the first metal layers, the second metal layers, and the bottom metal layers are connected with each other by end to end way, so as to jointly form the metal coil. Moreover, the third metal layer on the second middle magnetic material layer and the first metal layer on the first middle magnetic material layer adjacent to the second middle magnetic material layer have a second line width ratio, and the line width ratio is ranged between 0.60 and 0.85.

Moreover, according to the preferable embodiment of the electronic component module, at least one electrode connecting hole is formed on the top magnetic material layer, the plurality of the first middle magnetic material layers, the at least one non-magnetic material layer, and the bottom magnetic material layer, used to facilitate at least one of the plurality of the first welding electrodes be electrically connected to at least one of the plurality of the second welding electrodes.

Furthermore, according to the preferable embodiment of the electronic component module, at least one reflow soldering electrode is formed on at least one corner of the top magnetic material layer, the plurality of the first middle magnetic material layers, the at least one non-magnetic material layer, and the bottom magnetic material layer, such that the first welding electrodes can electrically connect to the second welding electrodes through the soldering electrodes 19 by using solder paste.

### BRIEF DESCRIPTION OF THE DRAWINGS

The invention as well as a preferred mode of use and advantages thereof will be best understood by referring to the following detailed description of an illustrative embodiment in conjunction with the accompanying drawings, wherein:

FIG. 1 shows a stereo view of a conventional multilayer stacked inductor;

FIG. 2 shows a cross sectional view of the conventional multilayer stacked inductor;

FIG. 3 shows an exploded view of a helical coil unit in the multilayer stacked inductor;

FIG. 4 shows an exploded view of an improved helical coil unit;

FIG. 5 shows a stereo view of a novel multilayer stacked inductor according to the present invention;

FIG. 6 shows an exploded view of the novel multilayer stacked inductor according to the present invention;

FIG. 7 shown a cross sectional view of the novel multilayer stacked inductor;

FIG. 8 shows a curve plot of line width ratio and resistance of the novel multilayer stacked inductor;

FIG. 9 shows a curve plot of frequency and quality factor of the novel multilayer stacked inductor;

FIG. 10 shows another one cross sectional view of the novel multilayer stacked inductor;

FIG. 11A shows a stereo view of an electronic component module according to the present invention;

FIG. 11B shows another one stereo view of the electronic component module; and

FIG. 12 shows an exploded view of the electronic component module according to the present invention.

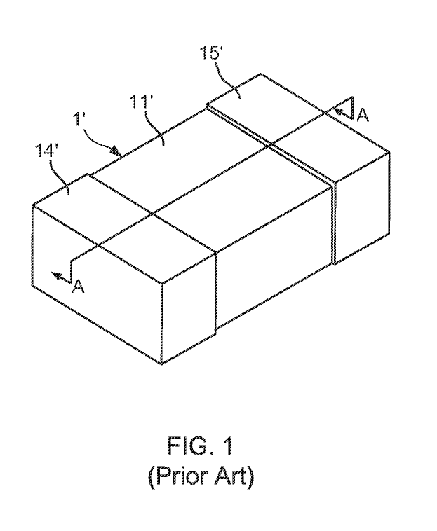

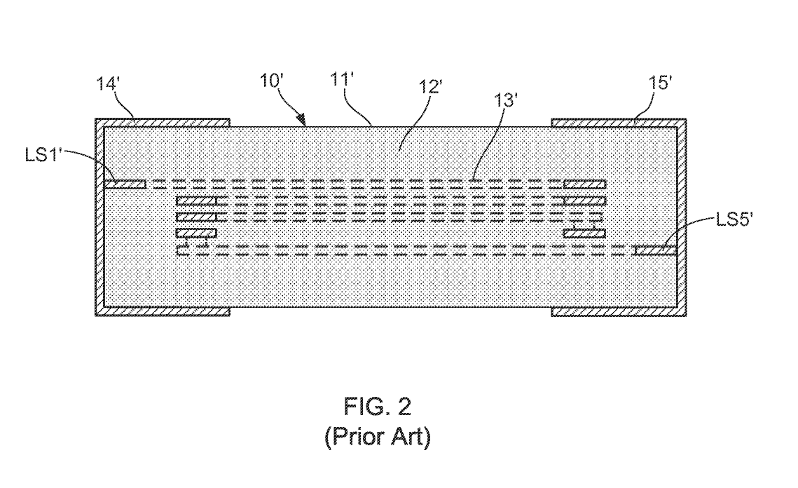

### DETAILED DESCRIPTION OF THE PREFERRED EMBODIMENTS

To more clearly describe a novel stacked inductor and an electronic component module having the novel stacked inductor according to the present invention, embodiments of the present invention will be described in detail with reference to the attached drawings hereinafter.

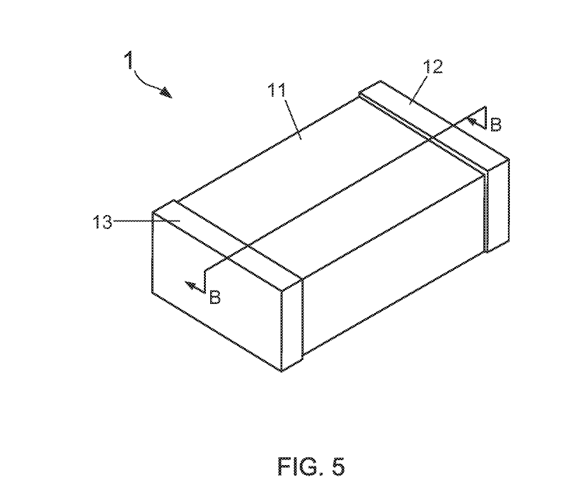

Referring to FIG. 5, there is shown a stereo view of a novel multilayer stacked inductor according to the present invention. As shown in FIG. 5, the novel multilayer stacked inductor 1 mainly consists of: a main body 11, a first welding electrode 12 and a second welding electrode 13, wherein the first welding electrode 12 and the second welding electrode 13 are respectively formed on two terminal sides of the main body 11.

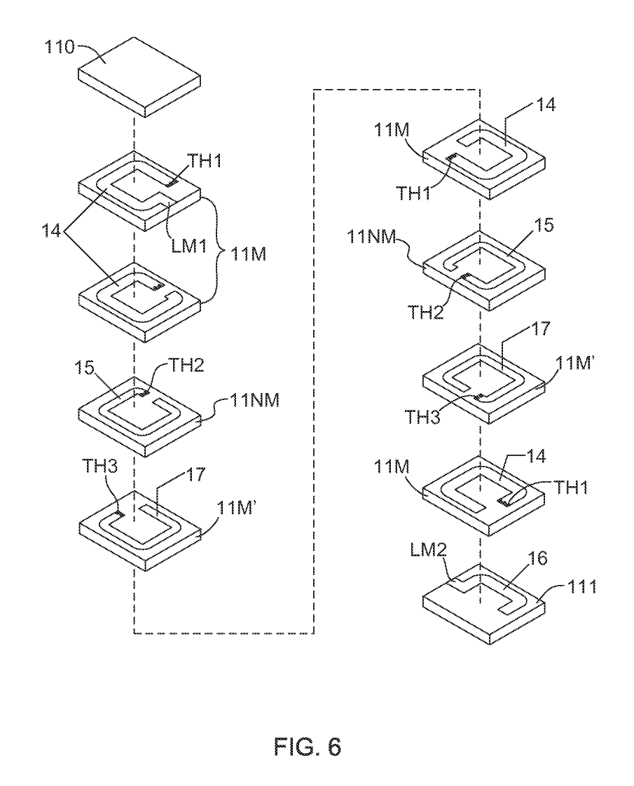

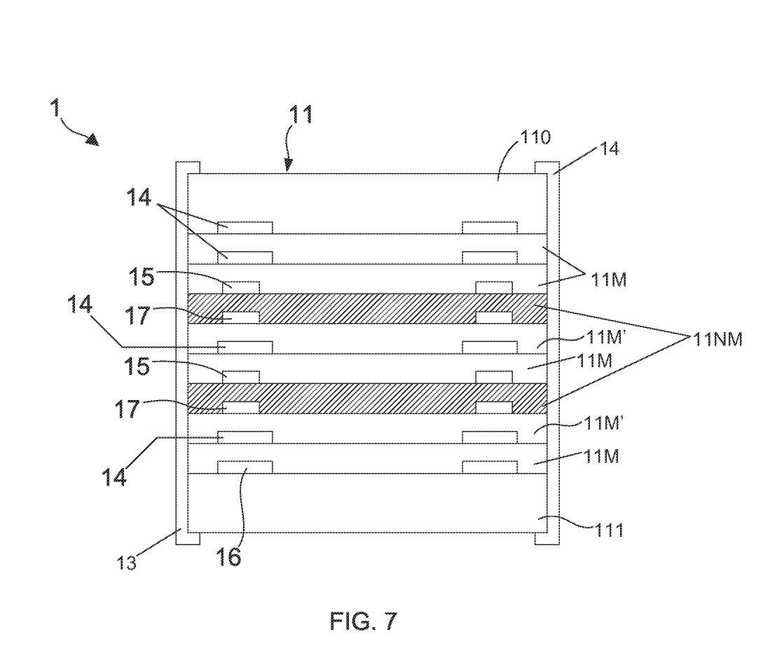

Please simultaneously refer to FIG. 6, where an exploded view of the novel multilayer stacked inductor 1 is shown. Moreover, please simultaneously refer to FIG. 7, which illustrates a cross sectional view of the novel multilayer stacked inductor 1. The cross sectional diagram of FIG. 7 is obtained by cutting the novel multilayer stacked inductor 1 along the B-B profile line shown in FIG. 5. Therefore, from the FIGs, it can find that the main body 11 is fabricated by stacking a top magnetic material layer 110, a plurality of first middle magnetic material layers 11M, two second middle magnetic material layers 11M′, two non-magnetic material layers 11NM, and a bottom magnetic material layer 111. FIG. 6 reveals four first middle magnetic material layers 11M, and each the non-magnetic material layer 11NM is disposed one first middle magnetic material layers 11M and one second middle magnetic material layers 11M′.

In the present invention, each of the first middle magnetic layer 11M and each of the non-magnetic material layer 11NM are provided with a first metal layer 14 and a second metal layer 15 thereon; moreover, each of the second middle magnetic material layer 11M′ are provided with a third metal layer 17 thereon. In addition, a bottom metal layer is formed on the bottom magnetic material layer 111. Furthermore, each the first middle magnetic material layer 11M, each the non-magnetic material layer 11NM, and each the second middle magnetic material layer 11M′ are dug with a first through hole TH1, a second through hole TH2, and a third through hole TH3, respectively. Such that, all the first metal layers 14, the second layers 15, the third metals 17, and the bottom metal layer 16 can connect to each other through the first through holes TH1, the second through holes TH2 and the third through hole TH3, so as to jointly form a metal coil in the main body 11.

Moreover, a first extension layer LM1 is extended from the first metal layer 14 on one of the plurality of first middle magnetic material layer 11M, and a second extension layer LM2 is extended from the bottom metal layer 16. Therefore, one terminal of the metal coil is able to connect with the first welding electrode 12 through the first extension layer LM1, and the other terminal of the metal coil can connect with the second welding electrode 13 through the second extension layer LM2.

In the present invention, each of the top magnetic material layer 110, the first middle magnetic material layers 11M, and the bottom magnetic material layer 111 are fabricated from a ceramic sheet made of at least one ferrite magnetic materials. However, differing from the top magnetic material layer 110, the first middle magnetic material layers 11M, and the bottom magnetic material layer 111, the non-magnetic material layer 11NM is fabricated from a ceramic sheet. Besides, the first metal layer 14, the second metal layer 15, the bottom metal layer 16, and the third metal layer 17 are made of silver or silver alloy.

The primary technique feature is to make the second metal layer 15 on the non-magnetic material layer 11NM and the first metal layer 14 on the first middle magnetic material layer 11M adjacent to the non-magnetic material layer 11NM have a first line width ratio, and let the third metal layer 17 on the second middle magnetic material layer 11M′ and the first metal layer 14 on the first middle magnetic material layer 11M adjacent to the second middle magnetic material layer 11M′ have a second line width ratio. Preferably, the first line width ratio and the second line width ratio are ranged between 0.60 and 0.85.

In order to prove that the above-mentioned technique feature can facilitate the novel multilayer stacked inductor 1 reveal inventive efficiency, different first line width ratio and the second line width ratio are arranged in following Table 1.

TABLE 1

| line width of the second metal layer 15 Wₘ₂ (μm) | line width of the second metal layer 17 Wₘ₃ (μm) | line width of the second metal layer 14 Wₘ₁ (μm) | first line width ratio $\frac{{W}_{m 2}}{{W}_{m 1}}$ | second line width ratio $\frac{{W}_{m 3}}{{W}_{m 1}}$ |
|---|---|---|---|---|
| 350 | 350 | 500 | 0.667 | 0.667 |
| 400 | 400 | 500 | 0.778 | 0.778 |
| 450 | 450 | 500 | 0.889 | 0.889 |
| 500 | 500 | 500 | 1 | 1 |

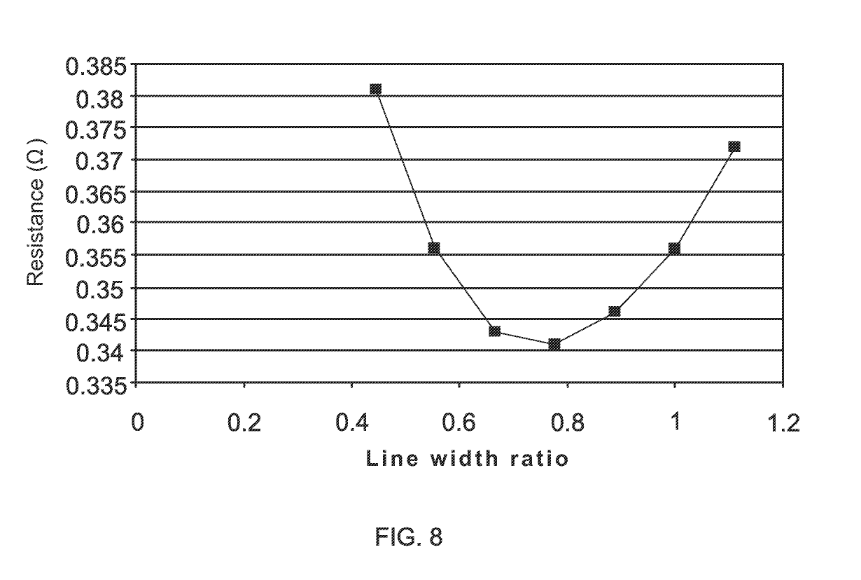

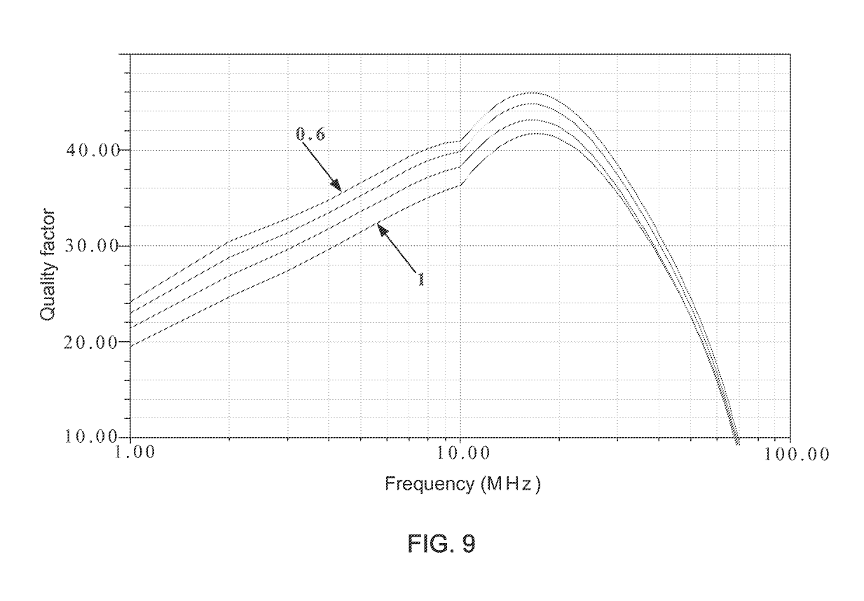

Please refer to FIG. 8. where a curve plot of line width ratio and resistance of the novel multilayer stacked inductor is presented; moreover, please refer to FIG. 9, which shows a curve plot of frequency and quality factor of the novel multilayer stacked inductor. From FIG. 8 and FIG. 9, it is able to find that, when the first line width ratio (Wₘ₂/Wₘ₁) and the second line width ratio (Wₘ₃/Wₘ₁) are 0.6, the DC resistance of the novel multilayer stacked inductor 1 is around 0.34Ω. In addition, when the first line width ratio (Wₘ₂/Wₘ₁) and the second line width ratio (Wₘ₃/Wₘ₁) are 1, the DC resistance of the novel multilayer stacked inductor 1 is around 0.36Ω. According to data of FIG. 8, the DC resistance of the novel multilayer stacked inductor 1 does not obviously increase with the reduction of the second metal layer 15 and the third metal layer 17. On the other hand, when the first line width ratio (Wₘ₂/Wₘ₁) and the second line width ratio (Wₘ₃/Wₘ₁) are 0.6, the quality factor (Q) of the novel multilayer stacked inductor 1 reaches to 24.74. Moreover, when the first line width ratio (Wₘ₂/Wₘ₁) and the second line width ratio (Wₘ₃/Wₘ₁) are 1, the quality factor (Q) of the novel multilayer stacked inductor 1 reduce to 21.44 contrarily. According to data of FIG. 9, it is able to know that, although changing the value of first line width ratio and second line width ratio just slight optimize the DC resistance of the novel multilayer stacked inductor 1, the quality factor of the novel multilayer stacked inductor 1 can be determined to be obviously enhanced with the increasing of the inductance through the formula of Q=ωL/R. Furthermore, from the data of FIG. 8 and FIG. 9, it can also understand that, when the first line width ratio and the second line width ratio are 0.667, the novel multilayer stacked inductor has an optimized DC resistance. In addition, according to the increasing of the inductance, the novel multilayer stacked inductor has an optimized quality factor (Q) when the first line width ratio and the second line width ratio are 0.6.

Moreover, for further proving that the above-mentioned technique feature can facilitate the novel multilayer stacked inductor 1 reveal inventive efficiency, different line width design for the first metal layer 14 are integrated in following Table 2.

TABLE 2

| line width of one of the first metal layer 14 Wₘ₁ (μm) | line width of another one of the first metal layer 14 Wₘ₁′ (μm) | first line width ratio $\frac{{W}_{m 1}}{{W}_{m {1}^{′}}}$ |
|---|---|---|
| 350 | 500 | 0.667 |
| 400 | 500 | 0.778 |
| 450 | 500 | 0.889 |
| 500 | 500 | 1 |

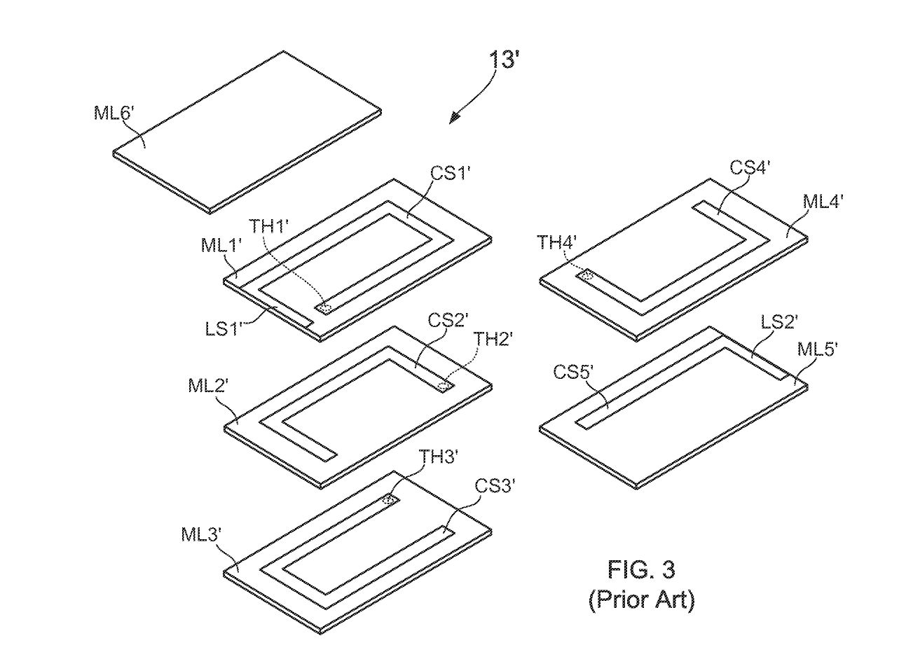

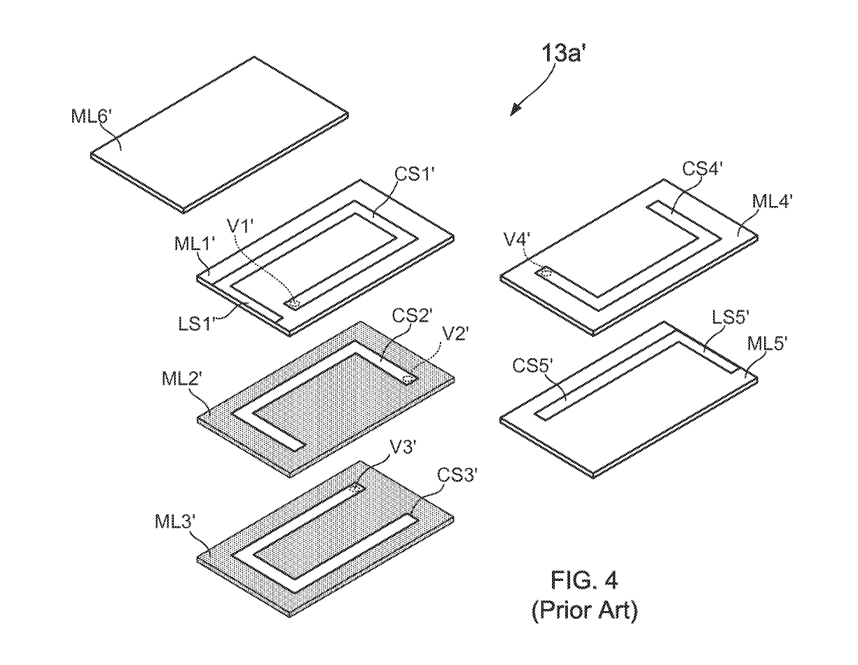

Therefore, through above descriptions, the novel multilayer stacked inductor 1 proposed by the present invention has been introduced completely and clearly; in summary, the novel multilayer stacked inductor 1 reveals the advantages of:
(1) Differing from the conventional multilayer stacked inductor shown by FIG. 3 and FIG. 4, the novel multilayer stacked inductor 1 proposed by the present invention is fabricated by stacking a top magnetic material layer 110, a plurality of first middle magnetic material layers 11M, two second middle magnetic material layer 11M′, two non-magnetic material layer 11NM, and a bottom magnetic material layer 111. Particularly, the present invention further let the second metal layer 15 formed on the non-magnetic material layer 11NM and the first metal layer 14 formed on the first middle magnetic material layer 11M adjacent to the non-magnetic material layer 11NM have a first line width ratio of 0.6˜0.85.
(2) Therefore, according to experimental data shown by FIG. 8 and FIG. 9, although changing the value of first line width ratio and second line width ratio just slight optimize the DC resistance of the novel multilayer stacked inductor 1, the quality factor of the novel multilayer stacked inductor 1 can be determined to be obviously enhanced with the increasing of the inductance through the formula of Q=ωL/R. Furthermore, it can also understand that when the first line width ratio and the second line width ratio are 0.667, the novel multilayer stacked inductor has an optimized DC resistance. In addition, according to the increasing of the inductance, the novel multilayer stacked inductor has an optimized quality factor (Q) when the first line width ratio and the second line width ratio are 0.6.

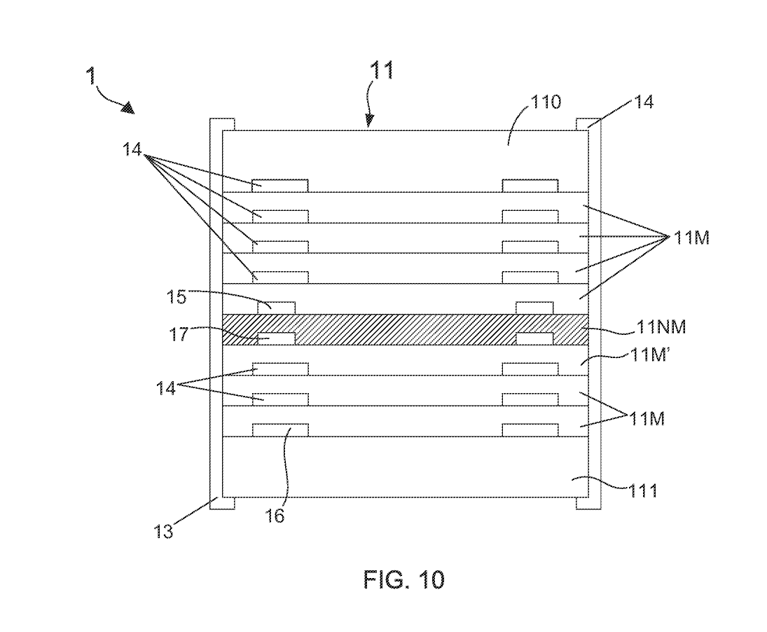

Herein, it needs to explain that, although the cross section diagram of FIG. 7 shows that the novel multilayer stacked inductor 1 includes two non-magnetic material layer 11NM, that cannot used to limit the practicable embodiment of the present invention. Please refer to FIG. 10, which illustrates another one cross sectional view of the novel multilayer stacked inductor 1. As FIG. 10 shows, in a practicable application, the novel multilayer stacked inductor 1 can just include one non-magnetic material layer 11NM. The most important technology feature is to make the first line width (Wₘ₂/Wₘ₁) and the second line width ratio (Wₘ₃/Wₘ₁) be ranged between 0.6 and 0.85, such that the novel multilayer stacked inductor 1 can therefore perform best operation frequency and quality factor.

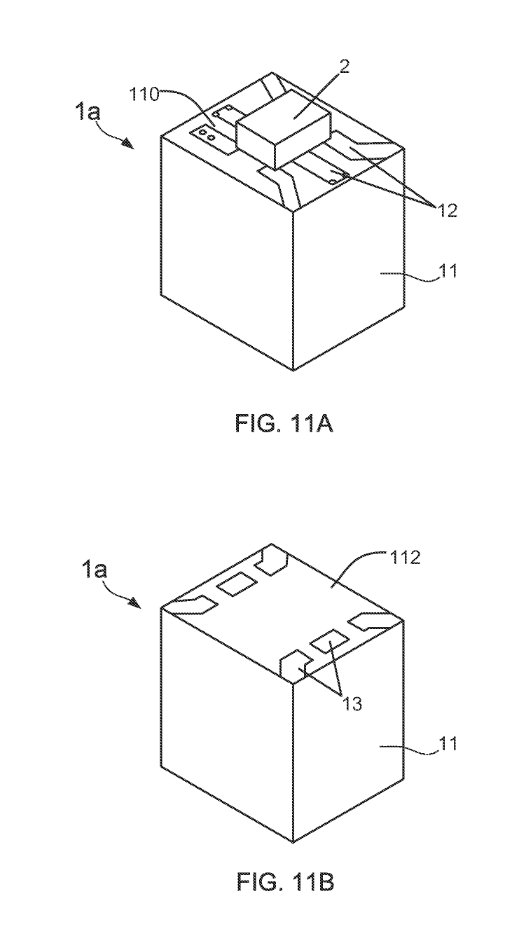

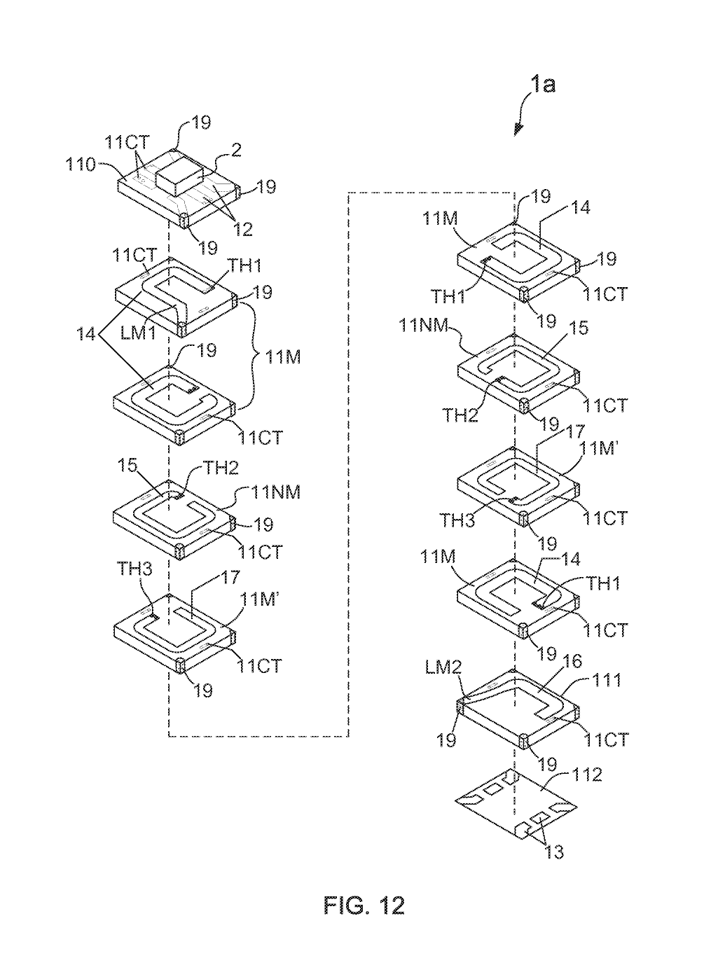

In spite of FIG. 5, FIG. 6 and FIG. 7 introducing that the novel multilayer stacked inductor 1 is one kind of SMD component, in practical applications, this novel multilayer stacked inductor 1 can also be integrated with others electronic components, such that an electronic component module having the novel multilayer stacked inductor 1 is therefore developed. Please refer to FIG. 11A and FIG. 11B, there are shown stereo views of the said electronic component module according to the present invention. Moreover, please simultaneously refer to FIG. 12 shows, where an exploded view of the electronic component module is shown. As shown in the Figures, the said electronic component module 1a is mainly consisted of: a main body 11, a plurality of first welding electrodes 12 and a plurality of second welding electrodes 13, wherein the main body 11 is fabricated by stacking a top magnetic material layer 110, a plurality of first middle magnetic material layers 11M, two second middle magnetic material layers 11M′, two non-magnetic material layers 11NM, a bottom magnetic material layers 111, and a soldering layer 112.

In the electronic component module 1a, the basic setup and design for the top magnetic material layer 110, the plurality of first middle magnetic material layers 11M, the two second middle magnetic material layers 11M′, the two non-magnetic material layers 11NM, and the bottom magnetic material layers 111 are the same to those applied in the novel multilayer stacked 1 shown by FIG. 6. For this reason, following paragraph will only introduce the particular features of the electronic component module 1a which does not introduced by FIG. 6.

Particularly, in this electronic component module 1a, the plurality of first welding electrodes 12 are formed on the top magnetic material layer 110, and used for being welded with at least one electronic component 2, so as to make the electronic component 2 be disposed on the top magnetic material layer 110 of the main body 11. The aforesaid electronic component 2 can be a DC/DC convert chip, a DC/AC convert chip, an AC/DC convert chip, an inductor component, or a capacitor component. Moreover, the amount and arrangement of the first welding electrodes 12 on the top magnetic material layer 110 are determined according to the amount and types of the electronic component 2.

Opposite to the first welding electrodes 12, the plurality of second welding electrodes 13 are formed on the soldering layer 112 for electrically connected to the first welding electrodes 12, respectively. In order to make the second welding electrodes 13 be able to respectively connected to the first welding electrodes 12, each of the top magnetic material layer 110, the plurality of the first middle magnetic material layer 11M, the at least one non-magnetic material layer 11NM, and the bottom magnetic material layer 111 must be provided with at least one electrode connecting hole 11CT, such that at least one of the plurality of first welding electrodes 12 can electrically connect to at least one of the plurality of second welding electrodes 13 through the electrode connecting holes 11CT. FIG. 12 exemplarily reveal that two first welding electrodes 12 respectively connect to two second welding electrodes 13 through the electrode connecting holes 11CT.

Inheriting to above descriptions, moreover, at least one reflow soldering electrode 19 is formed on at least one corner of the top magnetic material layer 110, the plurality of the first middle magnetic material layers 11M, the two non-magnetic material layer 11NM, and the bottom magnetic material layer 111, such that the first welding electrodes 12 can electrically connect to the second welding electrodes 13 through the reflow soldering electrodes 19 by using solder paste. FIG. 12 exemplarily reveal that three corners of the first middle magnetic material layers 11M, the two non-magnetic material layer 11NM and the bottom magnetic material layer 111 are formed with the reflow soldering electrode 19.

Moreover, a first extension layer LM1 is extended from the first metal layer 14 on one of the plurality of first middle magnetic material layer 11M, and the first extension layer LM1 also connects with the reflow soldering electrode 19 on the corner of the first middle magnetic material layer 11M, so as to make the metal coil connect to one of the plurality of the first welding electrodes 12 through the first extension layer LM1. On the other hand, a second extension layer LM2 is extended from the bottom metal layer 16, and the second extension layer LM2 also connects with the reflow soldering electrode 19 on the corner of the bottom magnetic material layer 111, so as to make the metal coil connect to one of the plurality of the second welding electrodes 13 through the second extension layer LM2.

The above description is made on embodiments of the present invention. However, the embodiments are not intended to limit scope of the present invention, and all equivalent implementations or alterations within the spirit of the present invention still fall within the scope of the present invention.

1. A novel multilayer stacked inductor, comprising:
a main body, being fabricated by stacking a top magnetic material layer, a plurality of first middle magnetic material layers, at least one non-magnetic material layer, and a bottom magnetic material layer, wherein each the non-magnetic material layer is disposed between two first middle magnetic material layers;
a first welding electrode, being formed on one terminal side of the main body;
a second welding electrode, being formed on another one terminal side of the main body;
wherein each the first middle magnetic material layer and each the non-magnetic material layer are respectively provided with a first metal layer and a second metal layer thereon, and a bottom metal layer being formed on the bottom magnetic material layer;
wherein the second metal layer on the non-magnetic material layer and the first metal layer on the first middle magnetic material layer adjacent to the non-magnetic material layer have a first line width ratio, and the first line width ratio being ranged from 0.60 to 0.85;
wherein all of the first metal layers on the plurality of first middle magnetic material layers, all of the second layers on the at least one non-magnetic material layer, and the bottom metal layer on the bottom magnetic material layer are connected with each other by end to end way, so as to jointly form a metal coil; moreover, two terminals of the metal coil are connected to the first welding electrode and the second welding electrode.

2. The novel multilayer stacked inductor of claim 1, wherein each the first middle magnetic material layer is provided with a first through hole thereon, and each the non-magnetic material layer is provided a second through hole thereon, such that all the first metal layers, the second layers and the bottom metal layer connect to each other through the first through holes and the second through holes.

3. The novel multilayer stacked inductor of claim 1, wherein each of the top magnetic material layer, the first middle magnetic material layers, and the bottom magnetic material layer are fabricated from a ceramic sheet made of at least one ferrite magnetic materials.

4. The novel multilayer stacked inductor of claim 1, wherein the non-magnetic material layer is fabricated from a ceramic sheet.

5. The novel multilayer stacked inductor of claim 1, wherein the first metal layer, the second metal layer and the bottom metal layer are made of silver or silver alloy.

6. The novel multilayer stacked inductor of claim 1, wherein a first extension layer is extended from the first metal layer on one of the plurality of first middle magnetic material layer, and the metal coil connecting to the first welding electrode through the first extension layer.

7. The novel multilayer stacked inductor of claim 2, further comprising at least one second middle magnetic material layer, wherein the second middle magnetic material layer is disposed below the non-magnetic material layer, and provided with a third metal thereon; therefore, all the first metal layers, the second layers, the third metal, and the bottom metal layer are connected with each other by end to end way, so as jointly form the metal coil.

8. The novel multilayer stacked inductor of claim 6, wherein a second extension layer is extended from the bottom metal layer, and the metal coil connecting to the second welding electrode through the second extension layer.

9. The novel multilayer stacked inductor of claim 7, wherein each of the second middle magnetic material are provided with a third through hole thereon, such that all the first metal layers, the second layers, the third metals, and the bottom metal layer can connect to each other through the first through holes, the second through holes and the third through hole.

10. The novel multilayer stacked inductor of claim 7, wherein each of the second middle magnetic material layers are fabricated from a ceramic sheet made of at least one ferrite magnetic materials.

11. The novel multilayer stacked inductor of claim 7, wherein the third metal layer is made of silver or silver alloy.

12. The novel multilayer stacked inductor of claim 7, wherein the third metal layer on the second middle magnetic material layer and the first metal layer on the first middle magnetic material layer adjacent to the second middle magnetic material layer have a second line width ratio, and the second line width ratio being ranged from 0.60 to 0.85.

13. An electronic component module, comprising:
a novel multilayer stacked inductor, comprising:
a main body, being fabricated by stacking a top magnetic material layer, a plurality of first middle magnetic material layers, at least one non-magnetic material layer, and a bottom magnetic material layer, wherein each the non-magnetic material layer is disposed between two first middle magnetic material layers;
a plurality of first welding electrodes, being formed on the top magnetic material layer; and;
a plurality of second welding electrodes, being formed on the soldering layer, and electrically connected to the first welding electrodes, respectively;
at least one electronic chip, being disposed on the top magnetic material layer by way of being welded onto the first welding electrodes;
wherein each the first middle magnetic material layer and each the non-magnetic material layer are respectively provided with a first metal layer and a second metal layer thereon, and a bottom metal layer being formed on the bottom magnetic material layer;
wherein the second metal layer on the non-magnetic material layer and the first metal layer on the first middle magnetic material layer adjacent to the non-magnetic material layer have a first line width ratio, and the first line width ratio being ranged from 0.60 to 0.85;
wherein all of the first metal layers on the plurality of first middle magnetic material layers, all of the second layers on the at least one non-magnetic material layer, and the bottom metal layer on the bottom magnetic material layer are connected with each other by end to end way, so as to jointly form a metal coil; moreover, one terminal of the metal coil is electrically connected to one of the plurality of first welding electrodes, and the other one terminal of the metal coil is electrically connected to one of the plurality of second welding electrodes.

14. The electronic component module of claim 13, wherein the electronic chip is selected from the group consisting of: DC/DC convert chip, DC/AC convert chip, AC/DC convert chip, inductor component, and capacitor component.

15. The electronic component module of claim 13, wherein each of the top magnetic material layer, the plurality of the first middle magnetic material layer, the at least one non-magnetic material layer, and the bottom magnetic material layer are provided with at least one electrode connecting hole thereon, such that at least one of the plurality of first welding electrodes electrically connect to at least one of the plurality of second welding electrodes through the electrode connecting holes.

16. The electronic component module of claim 13, wherein at least one reflow soldering electrode is formed on at least one corner of the top magnetic material layer, the plurality of the first middle magnetic material layers, the at least one non-magnetic material layer, and the bottom magnetic material layer, such that the first welding electrodes electrically connect to the second welding electrodes through the reflow soldering electrodes by using solder paste.

17. The electronic component module of claim 13, wherein each the first middle magnetic material layer is provided with a first through hole thereon, and each the non-magnetic material layer is provided with a second through hole thereon, such that all the first metal layers, the second layers and the bottom metal layer connect to each other through the first through holes and the second through holes.

18. The electronic component module of claim 13, wherein each of the top magnetic material layer, the first middle magnetic material layers, and the bottom magnetic material layer are fabricated from a ceramic sheet made of at least one ferrite magnetic materials.

19. The electronic component module of claim 13, wherein the non-magnetic material layer is fabricated from a ceramic sheet.

20. The electronic component module of claim 13, wherein the first metal layer, the second metal layer and the bottom metal layer are made of silver or silver alloy.

21. The electronic component module of claim 15, further comprising at least one second middle magnetic material layer, wherein the second middle magnetic material layer is disposed below the non-magnetic material layer, and provided with a third metal thereon; therefore, all the first metal layers, the second layers, the third metal, and the bottom metal layer are connected with each other by end to end way, so as jointly form the metal coil.

22. The electronic component module of claim 16, wherein a first extension layer is extended from the first metal layer on one of the plurality of first middle magnetic material layer, and the first extension layer also connecting with the reflow soldering electrode on the corner of the first middle magnetic material layer, so as to make the metal coil connect to one of the plurality of the first welding electrodes through the first extension layer.

23. The electronic component module of claim 22, wherein a second extension layer is extended from the bottom metal layer, and the second extension layer also connecting with the reflow soldering electrode on the corner of the bottom magnetic material layer, so as to make the metal coil connect to one of the plurality of the second welding electrodes through the second extension layer.

24. The electronic component module of claim 23, wherein each of the second middle magnetic material are provided with a third through hole thereon, such that all the first metal layers, the second layers, the third metals, and the bottom metal layer connect to each other through the first through holes, the second through holes and the third through hole.

25. The electronic component module of claim 23, wherein each of the second middle magnetic material layers are fabricated from a ceramic sheet made of at least one ferrite magnetic materials.

26. The electronic component module of claim 23, wherein the third metal layer is made of silver or silver alloy.

27. The electronic component module of claim 23, wherein the third metal layer on the second middle magnetic material layer and the first metal layer on the first middle magnetic material layer adjacent to the second middle magnetic material layer have a second line width ratio, and the second line width ratio being ranged from 0.60 to 0.85.
